(19) United States
(12) Patent Application Publication
(10) Pub. No.: US 2019/0112234 A1
(43) Pub. Date: Apr. 18, 2019

(54) Method to reduce radiation-induced conductivity in ceramic dielectrics via the incorporation of deep traps

(71) Applicant: National Technology & Engineering Solutions of Sandia, LLC, Albuquerque, NM (US)

(72) Inventors: Jonathan Anton Bock, Albuquerque, NM (US); Harlan James Brown-Shaklee, Albuquerque, NM (US)

(21) Appl. No.: 16/155,388

(22) Filed: Oct. 9, 2018

Related U.S. Application Data
(60) Provisional application No. 62/572,021, filed on Oct. 13, 2017.

(51) Int. Cl. C04B 35/468; H01G 4/12; C04B 35/626; C04B 35/634; C04B 35/638; C04B 35/64

(52) U.S. Cl. CPC C04B 35/4682; C04B 2235/604; H01G 4/1245; H01G 4/1254; C04B 35/6262; C04B 35/6264; C04B 35/62655; C04B 35/63416; C04B 35/63488; C04B 35/638; C04B 35/64; C04B 2235/3236; C04B 2235/3229; C04B 2235/96; H01G 4/1227

(57) ABSTRACT

The radiation-induced conductivity in ceramic dielectrics can be reduced via the incorporation of deep traps. For example, the addition of deep traps via substituting Ce onto the Ti site in BaTiO₃ reduces the radiation-induced conductivity by ˜30-40%.

### CROSS-REFERENCE TO RELATED APPLICATION

This application claims the benefit of U.S. Provisional Application No. 62/572,021, filed Oct. 13, 2017, which is incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to radiation effects in ceramic dielectric materials and, in particular, to a method to reduce the radiation-induced conductivity in ceramic dielectrics via the incorporation of deep traps.

### BACKGROUND OF THE INVENTION

Multilayer ceramic capacitors suffer from many deleterious effects under ionizing radiation. For example, gamma radiation from ⁶⁰Co can increase the defect density in ferroelectrics which will result in pinning domain walls, thereby decreasing the dielectric constant and remnant polarization. See S. A. Yang et al., Thin Solid Films 562, 185 (2014). Additionally, capacitors can discharge due to free carrier creation via activation of electrons across the band gap leading to significant leakage currents. Understanding and ultimately minimizing these effects are important for capacitors used in radioactive environments including extraterrestrial satellites, nuclear reactors, or robotics used for radioactive waste cleanup. While many studies have focused on ex-situ measurements of ferroelectric capacitors post-gamma radiation exposure, comparatively little study has been performed on the in-situ effects of radiation on capacitor materials, such as radiation-induced leakage currents. See J. M. Benedetto et al., IEEE Trans. Nucl. Sci. 37, 1713 (1990); J. Gao et al., Semicond. Sci. Technol. 14(9), 836 (1999); S. C. Lee et al., IEEE Trans. Nucl. Sci. 39(6), 2026 (1992); and R. W. Klaffky et al., Phys. Rev. B. 21(8), 3610 (1980).

### SUMMARY OF THE INVENTION

The present invention is directed to a method to reduce the radiation-induced conductivity in a ceramic capacitor, comprising doping the ceramic dielectric with a dopant that provides a deep trap in the dielectric layer. For example, the dielectric can comprise BaTiO₃. Other dielectrics can also be doped to reduce radiation-induced conductivity, such as (Ba₁₋ₓSrₓ)TiO₃, Pb(Zrₓ,Ti₁₋ₓ)O₃, Ca(Zrₓ,Ti₁₋ₓ)O₃, or (NaₓK₁₋ₓ)NbO₃. The dopant can comprise a neutral dopant, such as a lanthanide (e.g., Ce, Tb, Eu, Dy, Yb, Sm, or Pr). Alternatively, the dopant can comprise a positively charged donor, such as an early transition metal (e.g., Nb, La, V, Ta, W, Ce, Pr, Nd, Sm, Gd, Tb, Dy, Ho, Er, Tm, or Yb), compensated by an acceptor, such as a late transition metal (e.g., Cr, Mn, Fe, Co, Ni, Cu, Mo, Ru, Rh, Pd) or alkali metal (e.g., Na, K, or Li). Alternatively, the donor dopant or acceptor can be compensated by an intrinsic defect (e.g., La³⁺ can be compensated by titanium vacancies; Fe³⁺ can be compensated by oxygen vacancies). The concentration of the dopant can be sufficient to adequately reduce radiation-induced conductivity (e.g., >1 mol %), yet not so much as to degrade ferroelectric/dielectric properties (e.g., <10 mol %). The energy level of the deep trap is preferably greater than 20%, and more preferably about 50%, of the band gap energy of the dielectric.

As an example of the invention, the radiation-induced conductivities in BaTiO₃ and Ba(Ce_{0.05}, Ti_{0.95})O₃ were measured under multiple gamma ray dose rates. The dose-rate exponent of the radiation induced conductivity suggests Schottky-Read-Hall carrier recombination. Ce-doping was found to effectively decrease radiation-induced conductivity, and is likely due to the present of deep traps made by Ce_{Ti}^{x} defects.

### BRIEF DESCRIPTION OF THE DRAWINGS

The detailed description will refer to the following drawings, wherein like elements are referred to by like numbers.

FIG. 1 is a graph of leakage in a ceramic capacitor under gamma irradiation.

FIG. 2 is an energy level diagram of a deep trap in the band gap of an insulator.

FIG. 3 is a schematic illustration the substitution of a Ce atom for a Ti atom in the unit cell of BaTiO₃, creating a neutral Ce_{Ti}^{x} defect site.

FIG. 4 is a graph of the current passing through BaTiO₃ as a function of time before and during gamma irradiation.

FIG. 5 is a graph of Log current vs Log time for BaTiO₃ after voltage application under different gamma dose rates. Initial currents were adjusted to be equal at t=0. Sufficient time is needed to allow dielectric absorption to settle before σ_{RIC} can be measured.

FIG. 6(a) is a graph of current versus electric field for doped and undoped samples of BaTiO₃ is the low field regime. FIG. 6(b) is a graph of current versus electric field for doped and undoped samples of BaTiO₃ is the high field regime.

FIG. 7 is a Log-Log plot of Radiation-Induced Conductivity (RIC) vs. Dose Rate for BaTiO₃ and Ba(Ce_{0.05}, Ti_{0.95})O₃. A decrease in σ_{RIC} is seen after Ce doping.

FIG. 8 is a graph of the RC time constant for pure BaTiO₃, doped BaTiO₃, and Al₂O₃ as a function of dose rate. The data is also plotted on log-log axes (inset) and is linear.

### DETAILED DESCRIPTION OF THE INVENTION

One requirement for radiation-hard capacitors is the minimization of capacitor self-discharge under dose accumulation. This self-discharge is controlled by the RC time constant of the capacitor. As both R, resistance, and C, capacitance, have inversely proportional geometric factors, the RC time constant is geometrically independent and is given by:

$$RC = \frac{{ɛ}_{r} {ɛ}_{0}}{{σ}_{RIC}} \qquad ( 1 )$$

where εᵣ is the relative permittivity, εₒ is the permittivity of free space, and σ_{RIC} is the conductivity of the sample under radiation (i.e., radiation-induced conductivity, RIC). The time to discharge can therefore be minimized by 1) increasing the dielectric constant of the dielectric, or 2) decreasing the radiation-induced conductivity.

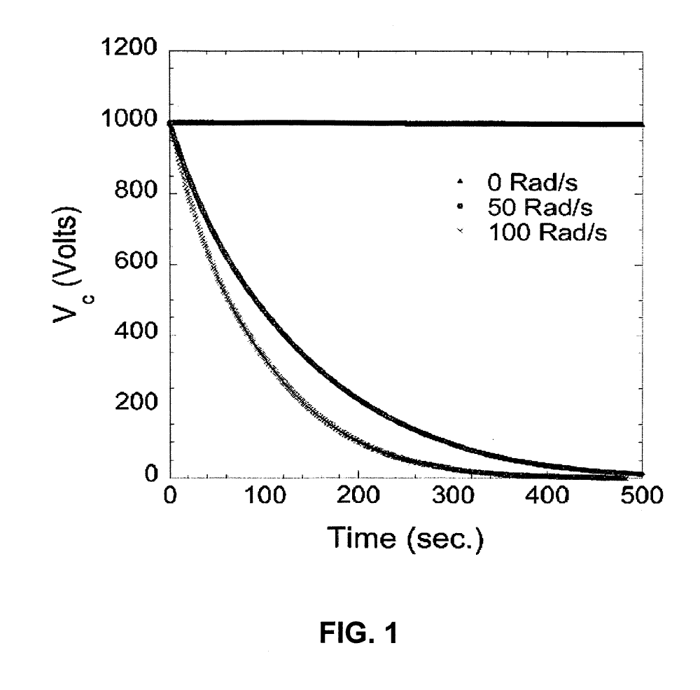

The origin of radiation-induced conductivity is the interaction of the material with the high-energy radiative particles. The example described below focuses on gamma irradiations that have energies (often >1 MeV) much greater than the band gap of common ceramic dielectrics (˜3 eV), resulting in free electron creation. The free charge carriers reduce the insulation resistance of the dielectric, causing charge loss and consequent voltage droop. FIG. 1 shows the leakage of a ceramic capacitor upon gamma radiation exposure. The decay is controlled by the RC time constant.

Given the presence of mobile charge carriers, this radiation-induced conductivity can be split into the nominal components:

σ=neμ (2)

where n is the carrier concentration, e is the charge of the charge carrier, and μ is the charge carrier mobility. While σ_{RIC} should follow this common law, complications arise compared to normal photoconductors. In a photoconductor the carrier concentration is a function of trap density, defect capture cross section, rate of reemission from shallow carriers, and the nature of lattice relaxation around deep trap states. See M. C. Tarun et al., Phys. Rev. Lett. 111, 187403 (2013). However, due to damage cascade processes upon gamma-ray absorption, a large number of electron-hole pairs are made in close proximity and a large amount of geminate recombination occurs in dielectrics which likely makes additional factors, such as the applied electric field, local electric field magnitude, and dielectric constant, important parameters. See R. C. Hughes, J. Chem. Phys. 55, 5442 (1971). The complicated nature of the phenomenon along with the overall lack of widespread access to equipment suitable for in-situ measurement of conductivity under gamma irradiation environments makes for a dearth of fundamental knowledge about the subject with a scattered literature. See L. W. Hobbs et al., J. Nucl. Mater. 216, 291 (1994).

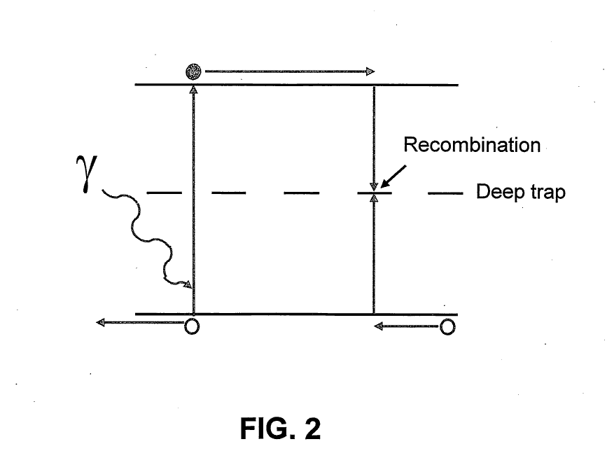

The present invention is directed to a method to reduce the radiation-induced conductivity in a dielectric ceramic capacitor, comprising doping the dielectric with a dopant that provides deep traps within the bandgap of the dielectric. Assuming photoconductivity adequately explains conductivity under gamma radiation, the radiation-induced conductivity can be reduced by minimizing the mobility-lifetime product. As shown in FIG. 2, the carrier lifetime can be reduced by adding deep traps in the bandgap of the material, resulting in recombination of the charge carriers via defect states.

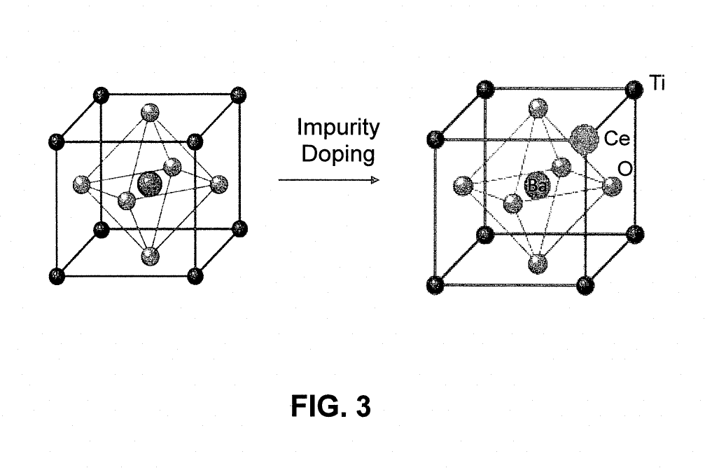

The radiation-induced conductivity of BaTiO₃ and cerium-doped BaTiO₃ was systematically measured. Ce was chosen as a dopant due to a clear understanding of its energy level resulting from its use in photorefractive crystals, as well as its nature as a deep trap (1.5 eV) which should minimize trapped carrier re-emission. See H. Song et al., Appl. Phys. B 70, 543 (2000). As shown in FIG. 3, the Ce atom substitutes for a Ti atom in the unit cell, creating a neutral Ce_{Ti}^{x} defect site.

Samples of BaTiO₃ and Ba(Ce_{0.05}, Ti_{0.95})O₃ were fabricated by the solid-state reaction of BaCO₃, TiO₂, and CeO₂. Correct ratios of the precursors were mixed via ball milling with ˜2 mm diameter ZrO₂ milling media in ethanol in a high-density polyethylene bottle. Mixed powders were dried via roto-evaporation and calcined at 900° C. for 6 hrs. Calcined powders were ball milled in DI water for 24 hrs by the same method as mixing. At the end of milling, PVA-PEG was added to the ceramic-water mixture which was subsequently frozen using a shell bath after which the ice was sublimed using a vacuum manifold. The resulting powder was pressed via uniaxial pressing at ˜13 MPa, followed by cold isostatic pressing at ˜120 MPa. The binder was removed via heating to 500° C. at 3° C./min and holding for 5 hours. The resulting pellets were sintered at 1350° C. resulting in sintered pellets with >95% relative density. The pellets were electroded with Cr/Au electrodes and the dielectric constant and loss were measured from room temperature to 140° C., showing nominal dielectric response with and tan δ<0.02 at 1 kHz. See Z. Jing et al., J. Mater. Res. 38, 1057 (2003).

A Gamma Irradiation Facility (GIF) was utilized for radiation exposure of the pellet samples. The GIF contained of an array of ⁶⁰Co sources. The gamma dose rate could be controlled by distance from the array to the sample. The electrode pattern on the samples was designed for in-situ radiation measurements. One side of the sample was covered with a blanket electrode. The other side was patterned with an inner circle electrode surrounded by a ring along the outer edge of the sample. The outer ring acted as a guard electrode to prevent conductivity from surface conduction along the edge of the sample during measurements under radiation. Measurements of conductivity under radiation were performed using a source-measure unit to apply 5-20 volts to the blanket electrode while a picoammeter was used to measure the current through the inner electrode. All reported dose rates are applied dose rates and not absorbed dose rates.

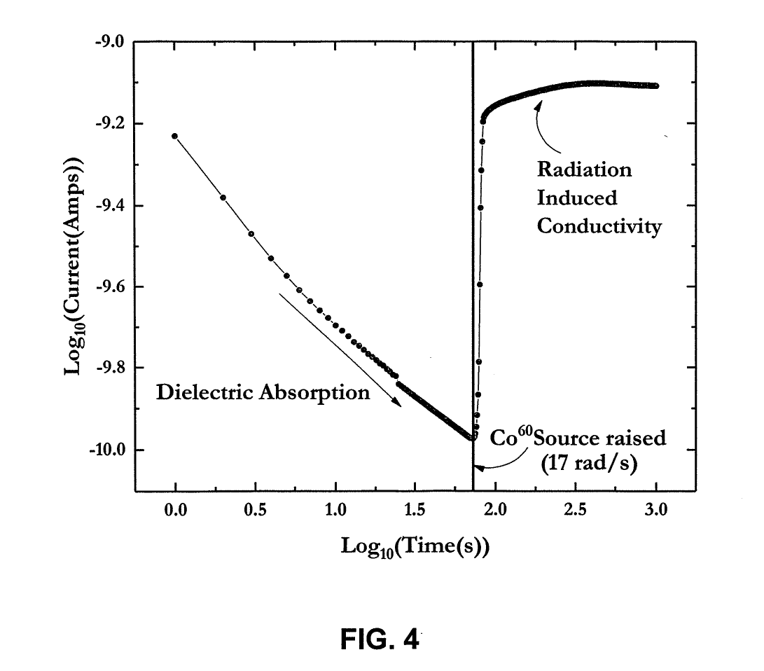

FIG. 4 shows the current passing through BaTiO₃ under a 20V application as a function of time while the sample was exposed to the gamma ray source. Before the application of gamma irradiation, the current passing through the sample decreases roughly linearly on a log-log scale as is expected via the Curie Von Schweidler law, and is therefore attributed to dielectric absorption as well as sample and cable charging. Upon application of the gamma radiation field, the current through the sample increases significantly.

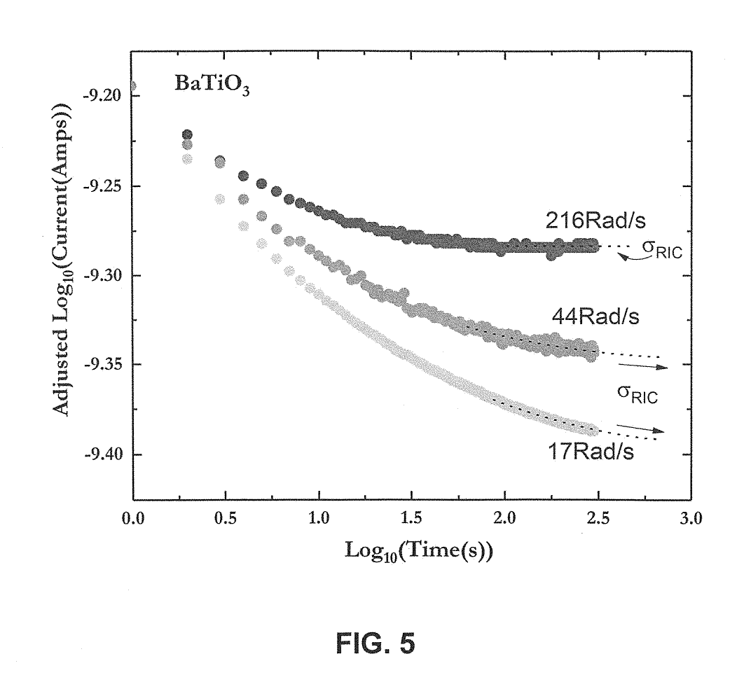

At these dose rates the initial current from charging and dielectric absorption and the radiation-induced conductivity are similar in magnitude. Therefore, it is important to take the dielectric absorption into account during measurement of σ_{RIC}. A series of current vs time plots for multiple dose rates are plotted for a BaTiO₃ sample in FIG. 5. Note that the curves are offset so that the initial currents are equal. At short times the charging and dielectric absorption currents are high, and these outweigh the current from σ_{RIC}. As time increases both the charging and dielectric absorption current decrease. For higher radiation doses (for example, 216 rad/s in FIG. 5) the conductivity for radiation-induced conductivity takes over within a few hundred seconds and σ_{RIC} can be properly measured. For lower dose rates (for example, 44 rad/s and 17 rad/s in FIG. 5), even after 300 s, the current has not settled to a continuous value and therefore the calculated σ_{RIC} is overestimated due to contributions from dielectric absorption. Longer hold times can be used to minimize the dielectric absorption contribution. Nonetheless, the difference between dose rates is large compared to the error from dielectric absorption.

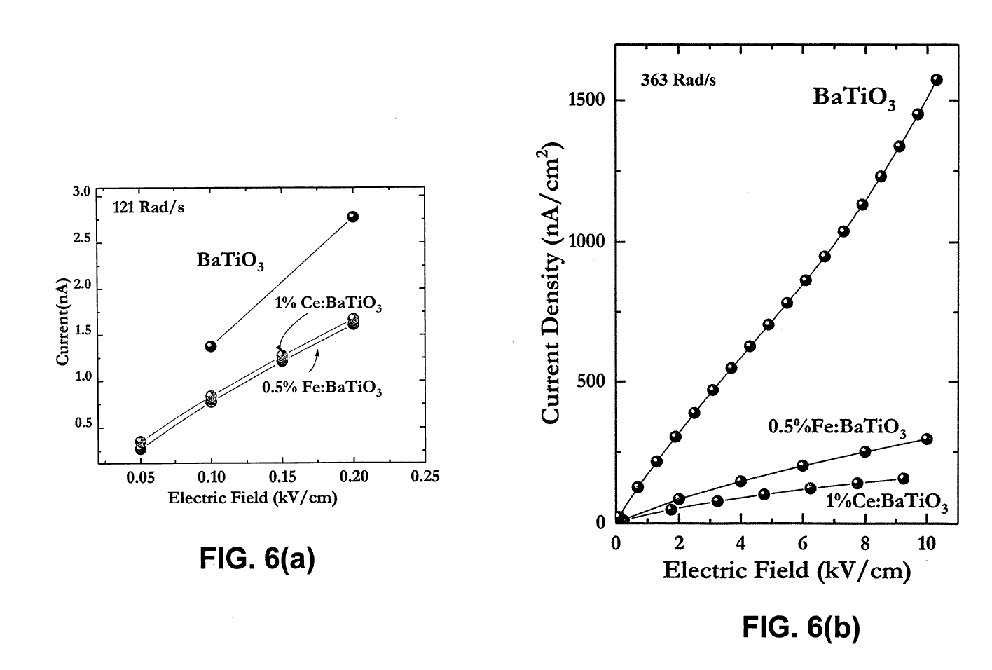

FIGS. 6(a) and 6(b) show the electric-field dependence of the current for bulk doped and undoped bulk samples under gamma irradiation. As shown in FIG. 6(a), in the low-dose, low-field regime both doped and undoped samples exhibit “ohmic” conduction at low fields. Both Ce and Fe doping result in decreases in radiation-induced conductivity compared to pure BaTiO₃. However, as shown in FIG. 6(b), in the high-dose, high-field regime, conduction is clearly non-linear with a negative curvature for the doped samples. The magnitude of the reduction in the radiation-induced conductivity is also much improved, with a reduction of ˜80% for Ba(Ce_{0.05}Ti_{0.95})O₃.

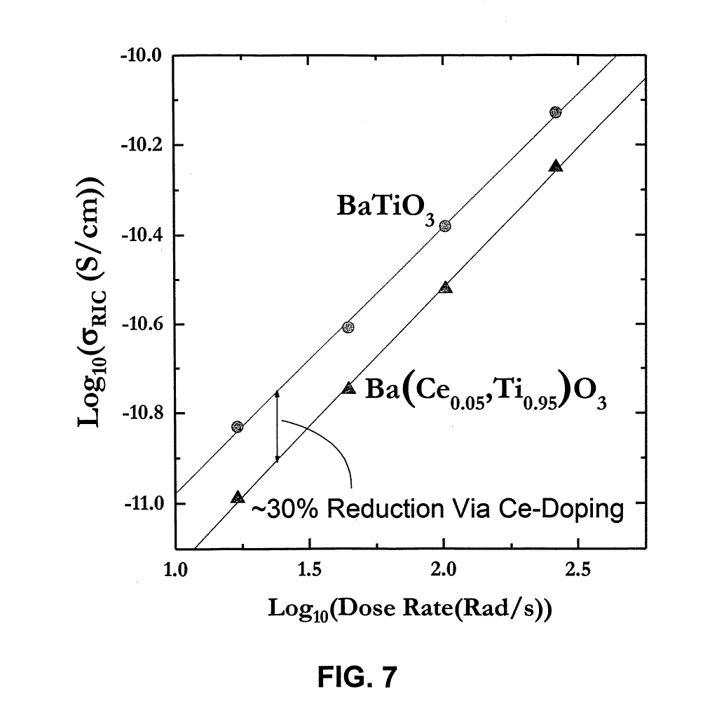

The radiation-induced conductivity as a function of dose rate for BaTiO₃ and BaCe_{0.05}Ti_{0.95})O₃ are plotted in FIG. 7. The Ce-doped BaTiO₃ has a reduced σ_{RIC} at all dose rates by ˜30-40% compared to pure BaTiO₃. This is attributed to the deep traps known to be formed by Ce within the band gap of BaTiO₃. See H. Song et al., Appl. Phys. B 70, 543 (2000).

This drop is comparable to, but less than, the effects of dopants in other systems such as Cr and Ni in Al₂O₃ which have shown decreases in σ_{RIC} by 70-100% with much lower concentrations (˜0.1 mol %). See K. Shiiyama et al., J. Nuc. Mat. 329-333, 1520 (2004). Nonetheless, the current data provides experimental proof that dopants can reduce σ_{RIC} in BaTiO₃-based capacitors. In the current composition, Ce is expected to lay on the Ti site as a neutral dopant (C_{Ti}^{x}). See Z. Jing et al., J. Mater. Res. 38, 1057 (2003); and D. Makovec et al., J. Solid State Chem. 123, 30 (1996). The neutral nature may be limiting the capture cross section of the deep trap, and it is expected that a positively charged donor (correctly compensated by an acceptor) may have a larger columbic attraction to the free electrons, resulting in a much larger capture cross section and more significant decrease in σ_{RIC}. This can also be accomplished by acceptor doping (e.g., Fe, Mn), as BaTiO₃ self-compensates via oxygen vacancy creation.

An additional aspect of the data in FIG. 7 is the slopes of the Log₁₀(σ_{RIC}) vs Log₁₀(Dose Rate) curves, which are 0.59 and 0.62 for BaTiO₃ and Ba(Ce_{0.05}, Ti_{0.95})O₃, respectively. These are comparable slopes to photoconductivity experiments in BaTiO₃, and the values laying between 0.5 and 1 suggest that the steady-state carrier concentration is controlled by Schottky-Read-Hall recombination as opposed to direct recombination of electrons and holes. See D. Mahgerefteh and J. Feinberg, Phys. Rev. Lett. 64, 2195 (1990); and K. C. Kao, Dielectric Phenomena in Solids, Elsevier Academic Press, London, UK, 480-514. This is the theoretically expected outcome for defect-heavy materials such as BaTiO₃ and doped BaTiO₃ made via conventional powder processing. However, these slopes should be interpreted with some caution. Lower dose rates were not allowed to completely settle for high accuracy σ_{RIC} determination (FIG. 5), and other effects such as the effect of changing electric fields during IV measurements on the geminate recombination rate and the effect of voltage history on dielectric absorption contributions may have an effect.

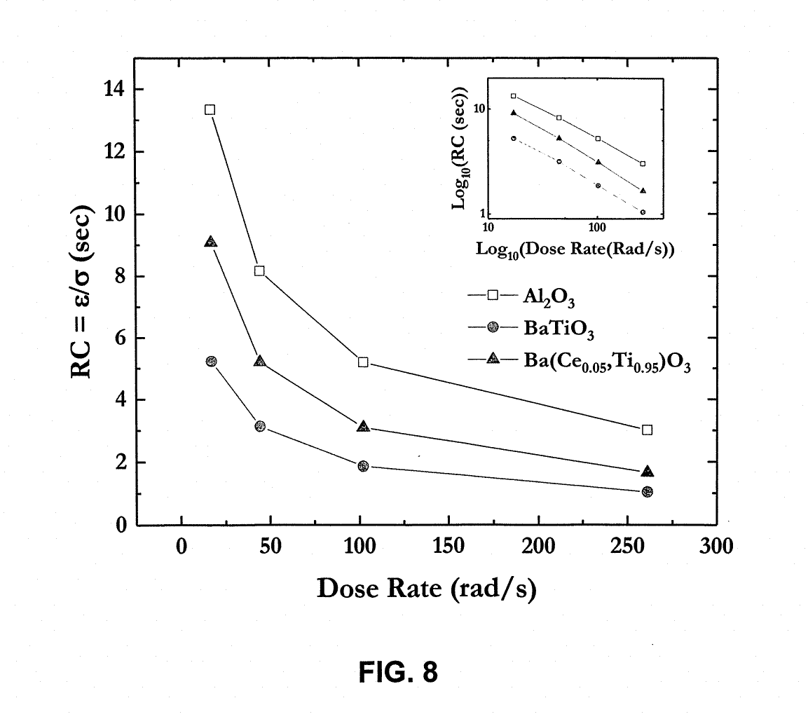

Finally, both permittivity and σ_{RIC} are pertinent to minimizing capacitor self-discharge under accumulated dose. This is easily seen in FIG. 8, where the RC time constant as a function of dose rate is plotted for pure and doped BaTiO₃ as compared to a commercial Al₂O₃ sample obtained from Coorstek. Similar RC time constants are found for all samples despite the large difference between BaTiO₃-based samples and Al₂O₃ in relative permittivity (˜3000 vs ˜10, respectively) and conductivity under gamma irradiation (˜10⁻¹⁰-10⁻¹¹ vs. ˜10⁻¹²-10⁻¹³, respectively). The permittivity of BaTiO₃ is relatively unchanged with the addition of 5% Ce_{Ti}^{x}, while the leakage is significantly decreased. The RC time constant therefore increases compared to pure BaTiO₃.

The present invention has been described as a method to reduce the radiation-induced conductivity in ceramic dielectrics via the incorporation of deep traps. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method to reduce the radiation-induced conductivity in a ceramic capacitor, comprising doping the ceramic dielectric of the capacitor with a dopant that provides a deep trap in the band gap of the ceramic dielectric.

2. The method of claim 1, wherein the dielectric comprises BaTiO₃.

3. The method of claim 1, wherein the dielectric comprises (Ba₁₋ₓSrₓ)TiO₃, Pb(Zrₓ,Ti₁₋ₓ)O₃, Ca(Zrₓ,Ti₁₋ₓ)O₃ or (NaₓK₁₋ₓ)NbO₃.

4. The method of claim 1, wherein the dopant comprises a neutral dopant.

5. The method of claim 4, wherein the neutral dopant comprises Ce.

6. The method of claim 4, wherein the neutral dopant comprises a lanthanide.

7. The method of claim 1, wherein the dopant comprises a positively charged donor compensated by an acceptor.

8. The method of claim 7, wherein the donor dopant comprises an early transition metal.

9. The method of claim 7, wherein the acceptor comprises a late transition metal or alkali metal.

10. The method of claim 7, wherein the acceptor or donor is compensated by an intrinsic defect.

11. The method of claim 1, wherein the concentration of dopant is less than 10 mol %.

12. The method of claim 1, wherein the energy level of the deep trap is greater than 20% of the band gap energy of the ceramic dielectric.
